(19) United States
(12) Patent Application Publication
(10) Pub. No.: US 2025/0240218 A1
(43) Pub. Date: Jul. 24, 2025

(54) METHOD FOR PREDICTING DEVICE PERFORMANCE CONSUMPTION, COMPUTER DEVICE, AND STORAGE MEDIUM

(71) Applicant: RUIJIE NETWORKS CO., LTD., Fuzhou (CN)

(72) Inventor: Wei YIN, Fuzhou (CN)

(73) Assignee: RUIJIE NETWORKS CO., LTD., Fuzhou (CN)

(21) Appl. No.: 19/175,018

(22) Filed: Apr. 10, 2025

Related U.S. Application Data
(63) Continuation of application No. PCT/CN2024/102138, filed on Jun. 27, 2024.

(30) Foreign Application Priority Data
Sep. 1, 2023 (CN) 202311126710.4

(51) Int. Cl. H04L 41/14

(52) U.S. Cl. CPC H04L 41/145

(57) ABSTRACT

A method for predicting device performance consumption, a computer device, and a storage medium. The method includes: acquiring first object information, and acquiring device information and second object information, where the first object information represents a first object that is ready to consume a device performance indicator of a network device in the network system, the device information represents a running status of the network device in the network system, and the second object information represents a second object that is consuming a performance indicator of the network device; and invoking a performance model to generate a prediction result based on the first object information and the device information, where the prediction result represents a device performance indicator to be consumed by the network device in the network system when the network device bears the first object and the second object.

### CROSS-REFERENCE TO RELATED APPLICATIONS

This application is a continuation of International Patent Application No. PCT/CN2024/102138 filed on Jun. 27, 2024, which claims priority to Chinese Patent Application No. 202311126710.4, filed with the China National Intellectual Property Administration on Sep. 1, 2023 and entitled “METHOD AND APPARATUS FOR PREDICTING DEVICE PERFORMANCE CONSUMPTION, COMPUTER DEVICE, AND STORAGE MEDIUM”, both of which are incorporated herein by reference in their entireties.

### TECHNICAL FIELD

This application relates to the field of Internet technologies, and in particular, to a method for predicting device performance consumption, a computer device, and a storage medium.

### BACKGROUND

In modern network environments, security becomes increasingly important, and firewalls basically exist in all networks. Functions integrated in firewalls, such as intrusion prevention system (IPS) and anti-virus (AV), are also increasing continuously. Usually, networks of different scales have different requirements for device performance of network devices, depending on different functions enabled.

### SUMMARY

Embodiments of this application provide a method for predicting device performance consumption, a computer device, and a storage medium.

According to a first aspect, this application provides a method for predicting device performance consumption. The method is applied to a network system and includes:
acquiring first object information, and acquiring device information and second object information, where the first object information represents a first object that is ready to consume a device performance indicator of a network device in the network system, the device information represents a running status of the network device in the network system, and the second object information represents a second object that is consuming a performance indicator of the network device in the network system; and
invoking a preset performance model to generate a prediction result based on the first object information, the device information, and the second object information, where the prediction result represents a device performance indicator that the network device needs to consume when the network device in the network system bears the first object and the second object.

In an embodiment, the first object information includes first function information, and the second object information includes second function information; and
the acquiring the first object information, and acquiring the device information and the second object information includes:
receiving the first function information sent by a terminal, and acquiring the device information and the second function information, where the first function information represents a function that the terminal is ready to enable, the device information includes terminal access configuration information and running information, the terminal access configuration information represents a threshold for a quantity of terminals allowed to connect to the network device, the running information includes a quantity of terminals already connected to the network device, and the second function information represents a function already enabled by the network device in the network system.

In this solution, the function that the terminal requires the network system to newly enable is determined by receiving the first function information sent by the terminal; and a configuration status of the network device in the network system, the performance indicator of the network device in the network system, and the function already enabled by the network device in the network system are obtained by acquiring the device information, thereby ensuring comprehensiveness of information acquisition.

In an embodiment, the invoking the preset performance model to generate the prediction result based on the first object information, the device information, and the second object information includes:
invoking the preset performance model to generate a target function range based on the first function information, the second function information, and the running information in the device information, where the target function range refers to an upper limit and a lower limit of a device performance indicator consumable by a terminal connected to the network device when the network device in the network system enables the function for the first function information and the function for the second function information; and
determining a prediction result of the first function information based on the terminal access configuration information in the device information and the target function range.

In this solution, the performance model generates the target function range based on the first function information, the second function information, and the running information in the device information, to achieve a technical effect of multi-perspective analysis to determine the upper limit and the lower limit of the device performance indicator consumable by the terminal connected to the network device, thereby ensuring accuracy of the target function range; and the prediction result is determined in a targeted manner based on device information of different network devices by determining the prediction result based on the terminal access configuration information and the target function range, while ensuring accuracy of the target function range, thereby ensuring accuracy of the prediction result.

In an embodiment, the network system includes a cloud and at least one second network device; and
the invoking the preset performance model to generate the target function range based on the first function information, the second function information, and the running information in the device information includes:
inputting, by the cloud, the first function information, the second function information, and running information in first device information into a preset performance analysis interface, where the first device information refers to device information of a first network device, and the first network device is a network device that is of the at least one second network device and that receives the first function information sent by the terminal; and
invoking, by the cloud, the performance model through the performance analysis interface, so that the performance model generates the target function range based on the first function information, the running information in the first device information, and the second function information.

In this solution, the cloud inputs the first function information, the second function information, and the running information in the first device information into the preset performance analysis interface, and invokes the performance model through the performance analysis interface, so that the performance model is invoked by the cloud by using the interface based on the first function information, thereby clarifying functions provided by the network device, reducing the coupling between other functions in the cloud and the performance model, and facilitating frequent training and maintenance of the performance model.

In an embodiment, the network system includes a cloud and at least one second network device; and
the determining the prediction result of the first function information based on the terminal access configuration information in the device information and the target function range includes:
multiplying, by the cloud, terminal access configuration information in first device information by the upper limit and the lower limit in the target function range respectively to obtain a predicted upper limit value and a predicted lower limit value, where the first device information refers to device information of a first network device, and the first network device is a network device that is of the at least one second network device and that receives the first object information sent by the terminal; and
constructing, by the cloud, a value range based on the predicted upper limit value and the predicted lower limit value, and using the value range as the prediction result.

In this solution, the cloud multiplies the terminal access configuration information in the first device information by an upper limit value and a lower limit value in the target function range respectively to obtain the predicted upper limit value and the predicted lower limit value, constructs the value range based on the predicted upper limit value and the predicted lower limit value, and uses the value range as the prediction result. In this way, a range of a performance indicator that may be consumed by the network device once all terminals enable the function for the first function information is determined in a targeted manner based on the terminal access configuration information of the network device, and the target function range of the performance indicator that may be consumed by the terminal when the terminal is connected to the network device, thereby greatly ensuring reliability of the prediction result.

In an embodiment, the first object information includes first function information, and the second object information includes second function information; and
the invoking the preset performance model to generate the prediction result based on the first object information, the device information, and the second object information includes:
invoking the preset performance model to generate a target function range based on the first function information in the first object information, the second function information in the second object information, and running information in the device information, where the target function range refers to an upper limit and a lower limit of a device performance indicator consumable by a terminal connected to the network device when the network device in the network system enables a function of the first function information and a function of the second function information; and
determining a prediction result of the first function information based on terminal access configuration information in the device information and the target function range.

In an embodiment, the first object information includes first capacity information, and the second object information includes second capacity information; and
the acquiring the first object information, and acquiring the device information and the second object information includes:
receiving the first capacity information sent by a terminal, and acquiring the device information and the second capacity information, where the first capacity information represents a quantity of terminals that the network device in the network system is ready to add, the device information includes enablement information, the enablement information represents a function enabled by the network device in the network system, and the second capacity information represents a quantity of terminals already connected to the network device in the network system.

In this solution, the quantity of terminals that need to be newly connected to the network system is determined by receiving the first capacity information sent by the terminal, and a configuration status of the network device in the network system, the performance indicator of the network device in the network system, and the quantity of terminals already connected to the network device in the network system are obtained by acquiring the device information, thereby ensuring comprehensiveness of information acquisition.

In an embodiment, the invoking the preset performance model to generate the prediction result based on the first object information, the device information, and the second object information includes:
invoking the preset performance model to generate a target capacity range based on the first capacity information, the second capacity information, and the enablement information in the device information, and using the target capacity range as a prediction result of the first capacity information, where the target capacity range refers to an upper limit and a lower limit of a device performance indicator consumed by the network device when a total of a first quantity and a second quantity of terminals are connected to the network device in the network system, the first quantity is a quantity of terminals corresponding to the first capacity information, and the second quantity is a quantity of terminals corresponding to the second capacity information.

In this solution, the performance model generates the target capacity range based on the first capacity information, running information in the device information, and the second capacity information, to achieve a technical effect of multi-perspective analysis to determine the upper limit and the lower limit of the device performance indicator consumable by the terminal connected to the network device, thereby ensuring accuracy of the target capacity range; and the prediction result is determined in a targeted manner based on device information of different network devices by determining the prediction result based on terminal access configuration information and the target capacity range, while ensuring accuracy of the target capacity range, thereby ensuring accuracy of the prediction result.

In an embodiment, before the acquiring the first object information, and acquiring the device information and the second object information, the method further includes:
collecting historical performance data for each type of running information in a functional scenario, where the functional scenario represents a function already enabled by the network device in the network system, the running information in the device information represents a quantity of terminals already connected to the network device in the network system, and the historical performance data represents a device performance indicator that is being consumed in the network system for a type of running information in the functional scenario;
obtaining a functional performance range of the functional scenario based on at least one piece of historical performance data corresponding to the functional scenario, where the functional performance range represents an upper limit and a lower limit of a device performance indicator of the network device consumable by a terminal in the functional scenario; and
training a preset initial model by using at least one functional scenario as input data and using a functional performance range corresponding to the at least one functional scenario as output data, to obtain the performance model.

In this solution, historical performance data for a plurality of types of running information in various functional scenarios is collected and used to train the initial model to obtain the performance model, thereby ensuring comprehensiveness of performance model training.

In an embodiment, the obtaining the functional performance range of the functional scenario based on the at least one piece of historical performance data corresponding to the functional scenario includes:
obtaining at least one piece of unit performance data in a target functional scenario based on at least one piece of historical performance data in the target functional scenario, where the unit performance data represents a device performance indicator consumed by a terminal in the target functional scenario;
performing a regression operation on each piece of unit performance data in the target functional scenario to obtain a regression curve of the target functional scenario, where the regression curve represents a probability that each category of unit performance data occurs in the target functional scenario, the category represents a value range to which a value of the unit performance data belongs, and the target functional scenario is one of the at least one functional scenario; and
inputting a preset regression range into the regression curve to obtain a functional performance range of the target functional scenario, where the regression range is used to determine a target range for extracting the category in the regression curve, the target range determines at least one target category in the regression curve, the functional performance range is used to cover unit performance data in the at least one target category, an upper limit of the functional performance range is a first value in the unit performance data in the at least one target category, and a lower limit of the functional performance range is a second value in the unit performance data in the at least one target category.

In this solution, the regression operation is performed on each piece of unit performance data to obtain the regression curve, and the functional performance range in the regression curve is determined based on the regression range, where the regression range defines a difference degree range, that is, an upper limit value and a lower limit value of unit performance data within an N % range in the regression curve, for example, an upper limit and a lower limit of unit performance data with an exposure probability of 90% in the regression curve (that is, a vast majority of the range in the curve), and the functional performance range is constructed based on the upper limit and the lower limit.

In an embodiment, before the acquiring the first object information, and acquiring the device information and the second object information, the method further includes:
collecting historical performance data for each type of enablement information in a capacity scenario, where the capacity scenario represents a quantity of terminals already connected to the network device in the network system, the enablement information represents a function already enabled by the network device in the network system, and the historical performance data represents a device performance indicator of the network device that is being consumed for a type of enablement information in the capacity scenario;
obtaining a capacity performance range of the capacity scenario based on at least one piece of historical performance data, where the capacity performance range represents an upper limit and a lower limit of a device performance indicator consumed by the network device in the capacity scenario; and
training a preset initial model by using at least one capacity scenario as input data and using a capacity performance range corresponding to the at least one capacity scenario as output data, to obtain the performance model.

In this solution, historical performance data for a plurality of types of running information in various capacity scenarios is collected and used to train the initial model to obtain the performance model, thereby ensuring comprehensiveness of performance model training.

In an embodiment, after the invoking the preset performance model to generate the prediction result based on the first object information, the device information, and the second object information, the method further includes:
comparing performance configuration information in the device information with the prediction result, where the performance configuration information represents a device performance indicator threshold consumable by the network device; and
if it is determined that the prediction result exceeds the performance configuration information, generating function alert information.

In this solution, the performance configuration information is compared with the prediction result, and the function alert information is generated to achieve a technical effect of timely feedback of a function enablement alarm.

In an embodiment, the invoking the preset performance model to generate the prediction result based on the first object information, the device information, and the second object information includes:
invoking the preset performance model to generate a target capacity range based on first capacity information in the first object information, second capacity information in the second object information, and enablement information in the device information, and using the target capacity range as a prediction result of the first capacity information, where the target capacity range refers to an upper limit and a lower limit of a device performance indicator consumed by the network device when a total of a first quantity and a second quantity of terminals are connected to the network device in the network system, the first quantity is a quantity of terminals corresponding to the first capacity information, and the second quantity is a quantity of terminals corresponding to the second capacity information.

According to a second aspect, an embodiment of this application provides an apparatus for predicting device performance consumption. The apparatus is installed in a network system and includes:
an input module, configured to acquire first object information, and acquire device information and second object information, where the first object information represents a first object that is ready to consume a device performance indicator of a network device in the network system, the device information represents a running status of the network device in the network system, and the second object information represents a second object that is consuming a performance indicator of the network device in the network system; and
a processing module, configured to invoke a preset performance model to generate a prediction result based on the first object information, the device information, and the second object information, where the prediction result represents a device performance indicator that the network device needs to consume when the network device in the network system bears the first object and the second object.

In an embodiment, the first object information includes first function information, and the second object information includes second function information; and
the input module is configured to receive the first function information sent by a terminal, and acquire the device information and the second function information, where the first function information represents a function that the terminal is ready to enable, the device information includes terminal access configuration information and running information, the terminal access configuration information represents a threshold for a quantity of terminals allowed to connect to the network device, the running information includes a quantity of terminals already connected to the network device, and the second function information represents a function already enabled by the network device in the network system.

In an embodiment, the processing module is configured to invoke the preset performance model to generate a target function range based on the first function information, the second function information, and the running information in the device information, where the target function range refers to an upper limit and a lower limit of a device performance indicator consumable by a terminal connected to the network device when the network device in the network system enables the function for the first function information and the function for the second function information; and
the processing module is further configured to determine a prediction result of the first function information based on the terminal access configuration information in the device information and the target function range.

In an embodiment, the network system includes a cloud and at least one second network device; and a processing module is disposed in the cloud;
the processing module in the cloud is configured to input the first function information, the second function information, and running information in first device information into a preset performance analysis interface, where the first device information refers to device information of a first network device, and the first network device is a network device that is of the at least one second network device and that receives the first function information sent by the terminal; and
the processing module in the cloud is configured to invoke the performance model through the performance analysis interface, so that the performance model generates the target function range based on the first function information, the running information in the first device information, and the second function information.

In an embodiment, the network system includes a cloud and at least one second network device; and a processing module is disposed in the cloud;
the processing module in the cloud is configured to multiply terminal access configuration information in first device information by the upper limit and the lower limit in the target function range respectively to obtain a predicted upper limit value and a predicted lower limit value, where the first device information refers to device information of a first network device, and the first network device is a network device that is of the at least one second network device and that receives the first object information sent by the terminal; and
the processing module in the cloud is configured to construct a value range based on the predicted upper limit value and the predicted lower limit value, and use the value range as the prediction result.

In an embodiment, the first object information includes first capacity information, and the second object information includes second capacity information; and
the input module is configured to receive the first capacity information sent by a terminal, and acquire the device information and the second capacity information, where the first capacity information represents a quantity of terminals that the network device in the network system is ready to add, the device information includes enablement information, the enablement information represents a function enabled by the network device in the network system, and the second capacity information represents a quantity of terminals already connected to the network device in the network system.

In the foregoing solution, the processing module is configured to invoke the preset performance model to generate a target capacity range based on the first capacity information, the second capacity information, and the enablement information in the device information, and use the target capacity range as a prediction result of the first capacity information, where the target capacity range refers to an upper limit and a lower limit of a device performance indicator consumed by the network device when a total of a first quantity and a second quantity of terminals are connected to the network device in the network system, the first quantity is a quantity of terminals corresponding to the first capacity information, and the second quantity is a quantity of terminals corresponding to the second capacity information.

In an embodiment, the apparatus further includes: a functional collection module, configured to collect historical performance data for each type of running information in a functional scenario, where the functional scenario represents a function already enabled by the network device in the network system, running information represents a quantity of terminals already connected to the network device in the network system, and the historical performance data represents a device performance indicator that is being consumed in the network system for a type of running information in the functional scenario;
a functional performance range module, configured to obtain a functional performance range of the functional scenario based on at least one piece of historical performance data corresponding to the functional scenario, where the functional performance range represents an upper limit and a lower limit of a device performance indicator of the network device consumable by a terminal in the functional scenario; and
a functional model training module, configured to train a preset initial model by using at least one functional scenario as input data and using a functional performance range corresponding to the at least one functional scenario as output data, to obtain the performance model.

In an embodiment, the functional performance range module is configured to obtain at least one piece of unit performance data in a target functional scenario based on at least one piece of historical performance data in the target functional scenario, where the unit performance data represents a device performance indicator consumed by a terminal in the target functional scenario;
the functional performance range module is configured to perform a regression operation on each piece of unit performance data in the target functional scenario to obtain a regression curve of the target functional scenario, where the regression curve represents a probability that each category of unit performance data occurs in the target functional scenario, the category represents a value range to which a value of the unit performance data belongs, and the target functional scenario is one of the at least one functional scenario; and
the functional performance range module is configured to input a preset regression range into the regression curve to obtain a functional performance range of the target functional scenario, where the regression range is used to determine a target range for extracting the category in the regression curve, the target range determines at least one target category in the regression curve, the functional performance range is used to cover unit performance data in the at least one target category, an upper limit of the functional performance range is a first value in the unit performance data in the at least one target category, and a lower limit of the functional performance range is a second value in the unit performance data in the at least one target category.

In an embodiment, the apparatus further includes a capacity collection module, configured to:
collect historical performance data for each type of enablement information in a capacity scenario, where the capacity scenario represents a quantity of terminals already connected to the network device in the network system, the enablement information represents a function already enabled by the network device in the network system, and the historical performance data represents a device performance indicator of the network device that is being consumed for a type of enablement information in the capacity scenario;
a capacity performance range module, configured to obtain a capacity performance range of the capacity scenario based on at least one piece of historical performance data, where the capacity performance range represents an upper limit and a lower limit of a device performance indicator consumed by the network device in the capacity scenario; and
a capacity model training module, configured to train a preset initial model by using at least one capacity scenario as input data and using a capacity performance range corresponding to the at least one capacity scenario as output data, to obtain the performance model.

In an embodiment, the apparatus further includes:
a comparison module, configured to compare performance configuration information in the device information with the prediction result, where the performance configuration information represents a device performance indicator threshold consumable by the network device; and
an alerting module, configured to generate function alert information if it is determined that the prediction result exceeds the performance configuration information.

According to a third aspect, an embodiment of this application further provides a computer device, including a processor and a memory communicatively connected to the processor, where
the memory stores computer-executable instructions; and
the processor executes the computer-executable instructions stored in the memory, to implement the foregoing method for predicting device performance consumption.

According to a fourth aspect, an embodiment of this application further provides a computer-readable storage medium, where the computer-readable storage medium stores computer-executable instructions, and when executed by a processor, the computer-executable instructions are used to implement the foregoing method for predicting device performance consumption.

According to a fifth aspect, an embodiment of this application further provides a computer program product including a computer program. When the computer program is executed by a processor, the foregoing method for predicting device performance consumption is implemented.

According to the method and apparatus for predicting device performance consumption, the computer device, and the storage medium provided in the embodiments of this application, the object that is ready to consume the device performance indicator of the network device is determined by receiving the first object information sent by the terminal, and the running status of the network device and the object that is consuming the performance indicator of the network device in the network system are acquired by acquiring the device information.

The preset performance model is invoked to generate the prediction result based on the first object information, the device information, and the second object information to predict, based on the device information of the network device, a device performance indicator that will be consumed by the network device when the network device adds a new object for consuming the device performance indicator, thereby ensuring accuracy of the prediction result and improving efficiency of generating the prediction result.

### BRIEF DESCRIPTION OF DRAWINGS

The accompanying drawings herein are incorporated into this specification and form a part of this specification. They illustrate embodiments conforming to this application and are intended to explain the principles of this application together with this specification.

FIG. 1 is a schematic diagram of an application scenario according to an embodiment of this application.

FIG. 2 is a flowchart of an embodiment of a method for predicting device performance consumption according to an embodiment of this application.

FIG. 3 is a flowchart of another embodiment of a method for predicting device performance consumption according to an embodiment of this application.

FIG. 4 is a graph of a normal distribution curve in another embodiment of a method for predicting device performance consumption according to an embodiment of this application.

FIG. 5 is a flowchart of still another embodiment of a method for predicting device performance consumption according to an embodiment of this application.

FIG. 6 is a schematic diagram of program modules in an apparatus for predicting device performance consumption according to an embodiment of this application.

FIG. 7 is a schematic diagram of a hardware structure of a computer device according to an embodiment of this application.

Embodiments of this application have been illustrated clearly in the foregoing drawings, and will be described in more detail hereinafter. These drawings and text descriptions are not intended to limit the scope of the conception of this application in any manner, but to illustrate the concept of this application to those skilled in the art by referring to specific embodiments.

### DETAILED DESCRIPTION OF EMBODIMENTS

Exemplary embodiments are described in detail herein, and examples of the exemplary embodiments are presented in the accompanying drawings. When the following description relates to the accompanying drawings, unless otherwise specified, same numbers in different accompanying drawings represent same or similar elements. Implementations described in the following exemplary embodiments do not represent all implementations consistent with this application. On the contrary, they are only examples of apparatuses and methods that are described in detail in the appended claims and are consistent with some aspects of the embodiments of this application.

Specific application scenarios of the embodiments of this application are as follows: In modern network environments, security becomes increasingly important, and firewalls basically exist in all networks. Functions integrated in firewalls, such as intrusion prevention system (IPS) and anti-virus (AV), are also increasing continuously. Usually, networks of different scales have different requirements for device performance of network devices, depending on different functions enabled. A simple example is as follows:

1. It is assumed that a performance baseline of a firewall (an upper limit of traffic that can be processed per second) is 1G.

2. After an IPS of the firewall is enabled, remaining performance of the firewall (the upper limit of the traffic that can be processed per second) is 300M.

3. When an AV function of the firewall is enabled, remaining performance of the firewall (the upper limit of the traffic that can be processed per second) is 200M.

4. When functions of the IPS and AV are enabled, remaining performance of the firewall (the upper limit of the traffic that can be processed per second) may be only 100M.

5. In an actual network environment, situations encountered are far more complex than these. In the actual environment, there may be various types of terminals, applications, and other complicated conditions.

6. Based on 5, when a user wants to adjust configurations and enable new functions in a network environment of the user, enablement of the new functions may cause degradation of device performance, and a fluctuation or even disconnection of a live network of the user.

However, when a firewall function is newly enabled in a network device, usually a device performance indicator of the network device that is consumed by the newly enabled function is manually predicted based on experience, resulting in low accuracy of a prediction result.

Because there is actually no software solution, it is usually determined manually. For example, when releasing a product, a device manufacturer may mark a typical function and a throughput that the product can support; or an engineer estimates, based on network conditions of the engineer, whether enablement of a function may affect performance, and then attempts to enable the function.

In view of the problem that it is impossible to determine in advance whether performance degradation may cause network disconnection after a function is enabled, an exemplary embodiment of this application can provide a method to notify a user of sufficient information before the user enables a function, so that the user can perceive a risk in advance. Through a large quantity of devices, traffic sample information of the devices is uploaded to a cloud. The cloud performs big data analysis to generate a traffic and function combination algorithm. When a new function needs to be enabled, the cloud may give, based on current traffic and function conditions, a prompt of a performance loss caused by the new function. This embodiment of this application can resolve a current problem that manually determining a newly enabled function based on experience and predicting a consumed device performance indicator of a network device cause low accuracy of a prediction result.

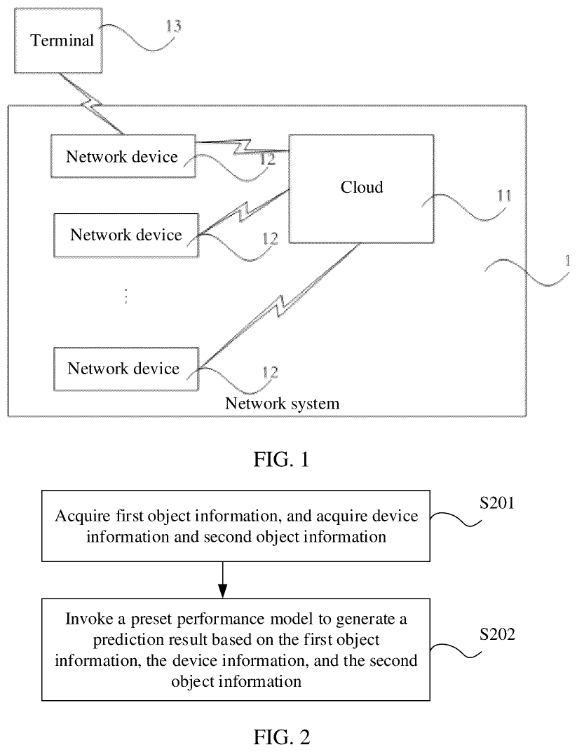

Referring to FIG. 1, the method for predicting device performance consumption is applied in a network system 1. The network system 1 includes a cloud 11 and at least one network device 12. The cloud 11 may refer to a cloud server. The cloud server (ECS, full name: Elastic Computing Service) is a simple, efficient, secure, and reliable computing service with elastically scalable processing capabilities. Management of the cloud server is simpler and more efficient than that of a physical server. The network device 12 is a physical entity connected to the network. The network device is equipped with network security protection devices such as a firewall and a security gateway. The firewall is a network device, and can monitor data packets entering and leaving the network, determine, according to preset rules, whether the data packets are legal, and if the data packets are illegal, reject transmission of the data packets. The security gateway is a multifunctional apparatus that has a network firewall function, an intrusion prevention function, an antivirus function, and the like. The cloud 11 is connected to at least one network device 12.

Specifically, the network device 12 receives first object information sent by the terminal 13, and acquires device information from the network device 12;
a preset performance model in the cloud 11 generates a prediction result based on the first object information and the device information, where the prediction result represents a device performance indicator consumed by the network device when objects corresponding to the first object information and the second object information are enabled; and
the cloud 11 sends the prediction result to the network device 12, and the network device 12 sends the prediction result to the terminal 13.

For impact of object enablement on the network device and/or impact of a quantity of newly connected terminals on the network device, an expected range of impact is provided. When a user actually uses the network device, usability is higher, and overall network stability can be controlled better.

The following uses specific embodiments to describe in detail the technical solution of this application and how the technical solution of this application resolves the current problem. The specific embodiments below may be combined with each other, and same or similar concepts or processes may not be described again in some embodiments. The following describes the embodiments of this application with reference to accompanying drawings.

In an exemplary embodiment, first object information is acquired, and device information and second object information are acquired, where the first object information represents an object that is ready to consume a device performance indicator of the network device in the network system, the device information represents a running status of the network device in the network system, and the second object information represents an object that is consuming a performance indicator of the network device in the network system. The first object information represents a function that the network device is ready to enable, the second object information represents a function already enabled by the network device, the device information includes terminal access configuration information and running information, the terminal access configuration information represents a threshold for a quantity of terminals allowed to connect to the network device, and the running information includes a quantity of terminals already connected to the network device. For example, a currently enabled function is function A, a function that is ready to be enabled is function B, and the terminal access configuration information indicates that a maximum quantity of terminals allowed to connect to the device is 10000. In this case, the cloud 11 predicts a device performance indicator that needs to be consumed when the network device 12 enables function A and function B and the network device 12 connects 10000 terminals.

A performance model is invoked to generate a prediction result based on the first object information, the device information, and the second object information, for example, predict the device performance indicator that needs to be consumed when the network device 12 enables function A and function B and the network device 12 connects 10000 terminals.

In another exemplary embodiment, first object information is acquired, and device information and second object information are acquired, where the first object information represents an object that is ready to consume a device performance indicator of the network device in the network system, the device information represents a running status of the network device in the network system, and the second object information represents an object that is consuming a performance indicator of the network device in the network system. The first object information is a quantity of terminals that the network device is ready to connect, for example, 500. The second object information is a quantity of terminals already connected to the network device, for example, 1000. The device information includes enablement information, and the enablement information represents a function enabled by the network device in the network system, for example, a device performance indicator consumed by the network device when the network device enables function A and function B and connects 1000 terminals. On this basis, if the network device is ready to connect 500 more terminals, the cloud 11 predicts a device performance indicator that needs to be consumed when the network device 12 enables function A and function B and connects 1500 terminals.

A performance model is invoked to generate a prediction result based on the first object information, the device information, and the second object information, for example, predict the device performance indicator that needs to be consumed when the network device 12 enables function A and function B and connects 1500 terminals. In still another exemplary embodiment, first object information is acquired, and device information and second object information are acquired, where the first object information represents an object that is ready to consume a device performance indicator of the network device in the network system, the device information represents a running status of the network device in the network system, and the second object information represents an object that is consuming a performance indicator of the network device in the network system. If the first object information represents a function that the network device is ready to enable, and the second object information represents a function already enabled by the network device, the device information includes terminal access configuration information and running information, where the terminal access configuration information represents a threshold for a quantity of terminals allowed to connect to the network device, and the running information includes a quantity of terminals already connected to the network device, and traffic of the network device in the network system. For example, a currently enabled function is function A, a function that is ready to be enabled is function B, the terminal access configuration information indicates that the device can connect a maximum of 10000 terminals, and the running information indicates that current traffic of the network device is 3000M. In this case, the cloud 11 predicts a device performance indicator that needs to be consumed by the network device 12 when the network device 12 enables function A and function B.

A performance model is invoked to generate a prediction result based on the first object information, the device information, and the second object information, for example, predict a device performance indicator that needs to be consumed when the network device 12 enables function A and function B and the network device 12 connects 10000 terminals and traffic is 3000M. In yet another exemplary embodiment, the first object information is a quantity of terminals that the network device is ready to connect, for example, 500. The second object information is a quantity of terminals already connected to the network device, for example, 1000.

The device information includes enablement information, and the enablement information represents a function enabled by the network device in the network system and traffic of the network device, for example, a device performance indicator consumed by the network device when the network device enables function A and function B and connects 1000 terminals and current traffic of the network device is 3000M. On this basis, if the network device is ready to connect 500 more terminals, the cloud 11 predicts a device performance indicator that needs to be consumed when the network device 12 enables function A and function B and connects 1500 terminals.

A performance model is invoked to generate a prediction result based on the first object information, the device information, and the second object information, for example, predict a device performance indicator that needs to be consumed when the network device 12 enables function A and function B and connects 1500 terminals and traffic is 3000M.

Referring to FIG. 2, this application provides a method for predicting device performance consumption. The method is applied to a network system and includes the following steps.

S201. Acquire first object information, and acquire device information and second object information, where the first object information represents an object that is ready to consume a device performance indicator of a network device in the network system, the device information represents a running status of the network device in the network system, and the second object information represents an object that is consuming a performance indicator of the network device in the network system.

In this step, the object that is ready to consume the device performance indicator of the network device is determined by receiving the first object information sent by a terminal, and/or receiving the first object information input by a user in the network device in the network system; and the running status of the network device and the object that is currently consuming the performance indicator of the network device in the network system are acquired by acquiring the device information.

In an embodiment, the first object information includes first function information, and the second object information includes second function information; and
the acquiring the first object information, and acquiring the device information and the second object information includes:
receiving the first function information sent by the terminal, and acquiring the device information and the second function information, where the first function information represents a function that the terminal is ready to enable, the device information includes terminal access configuration information and running information, the terminal access configuration information represents a threshold for a quantity of terminals allowed to connect to the network device, the running information includes a quantity of terminals already connected to the network device, and the second function information represents a function already enabled by the network device in the network system.

In an optional embodiment, the first object information includes first function information, and the second object information includes second function information; and
the acquiring the first object information, and acquiring the device information and the second object information includes:
receiving the first function information sent by the terminal, and acquiring the device information and the second function information, where the first function information represents a function that the terminal is ready to enable, the device information includes terminal access configuration information and running information, the terminal access configuration information represents a threshold for a quantity of terminals allowed to connect to the network device, the running information includes a quantity of terminals already connected to the network device and traffic of the network device in the network system, and the second function information represents a function already enabled by the network device in the network system.

In this step, the network device is configured to perform functional processing on a data packet by using the enabled function and the traffic of the network device, and send the processed data packet to each terminal. Therefore, the function that the terminal requires the network system to newly enable is determined by receiving the first function information sent by the terminal; and a configuration status of the network device in the network system, the performance indicator of the network device in the network system, and the function already enabled by the network device in the network system are obtained by acquiring the device information, thereby ensuring comprehensiveness of information acquisition. The traffic of the network device is a sum of amounts of data sent and received by the user during Internet access. The heavier the traffic, the more the data the terminal connected to the network device sends and receives, resulting in higher consumption of performance indicators.

In an embodiment, the first object information includes first function information, and the second object information includes second function information; and
the acquiring the first object information, and acquiring the device information and the second object information includes:
receiving, by a first network device, the first function information sent by the terminal, where the first network device is one of at least one network device, and the first network device is configured to provide a network environment for the terminal; and
extracting, by the first network device, first device information, and sending the first device information and the first function information to a cloud, where the first device information refers to device information of the first network device.

For example, the user opens a configuration management unit in the network device through the terminal, and sends the first function information to the configuration management unit through the terminal.

An information collection unit of the network device collects the terminal access configuration information, running information, and second function information of the network device. The information collection unit acquires the terminal access configuration information from the configuration management on a basis of the function corresponding to the second function information. For example, when the user is ready to make a function change, the change is definitely a change from Fa to Fb. In this case, by obtaining a maximum quantity K of terminals connected to this network device, Fa[Pn, Pm]*K->Fb[Pn, Pm]*K can be calculated, and Fb[Pn, Pm]*K is a desired predicted range of device performance consumption. Fa represents functional scenario a (function combination a), and Fb represents functional scenario b (function combination b). It is assumed that function A is enabled in functional scenario a corresponding to Fa, and that function A and function B are enabled in functional scenario b corresponding to Fb. Fa[Pn, Pm] is a functional performance range when the network device enables function A, Fb[Pn, Pm] is a target function range when the network device enables function A and function B; Fa[Pn, Pm]*K is a current performance consumption range of the network device, and Fb[Pn, Pm]*K is a desired predicted range of device performance consumption. Therefore, Fb[Pn, Pm]*K is a prediction result.

In another embodiment, the invoking the preset performance model to generate the prediction result based on the first object information, the device information, and the second object information includes:
invoking the preset performance model to generate a target capacity range based on the first capacity information, the second capacity information, and the enablement information in the device information, and using the target capacity range as a prediction result of the first capacity information, where the target capacity range refers to an upper limit and a lower limit of a device performance indicator consumed by the network device when a total of a first quantity and a second quantity of terminals are connected to the network device in the network system, the first quantity is a quantity of terminals corresponding to the first capacity information, and the second quantity is a quantity of terminals corresponding to the second capacity information.

In this way, the device performance indicator consumed by the network device is predicted based on the device information of the network device when a quantity of terminals corresponding to the first capacity information are newly connected to the network device, thereby ensuring accuracy of the prediction result and improving efficiency of generating the prediction result.

Therefore, the performance model generates the target capacity range based on the first capacity information, the running information in the device information, and the second capacity information, to achieve a technical effect of multi-perspective analysis to determine the upper limit and the lower limit of the device performance indicator consumable by the terminal connected to the network device, thereby ensuring accuracy of the target capacity range; and the prediction result is determined in a targeted manner based on device information of different network devices by determining the prediction result based on the terminal access configuration information and the target capacity range, while ensuring accuracy of the target capacity range, thereby ensuring accuracy of the prediction result.

Specifically, after the invoking the preset performance model to generate the prediction result based on the first object information, the device information, and the second object information, the method further includes:
sending the prediction result to the terminal.

In this step, the prediction result is sent to the terminal, so that the terminal can obtain the prediction result in time. Because the prediction result is generated based on the current device information of the network device, content of the prediction result will greatly fit with the current running status of the network device. In other words, impact of a new function or a specific quantity of newly connected terminals on the network device is determined based on different configurations of each network device, different device performance indicators, and different functions that are currently enabled. This greatly improves accuracy of the prediction. Therefore, this embodiment of this application is not only applicable to an application scenario in which the function enabled in the network device is changed, but also applicable to an application scenario in which the quantity of terminals connected to the network device is increased without expanding the bandwidth of the network device, thereby greatly broadening the application scope.

For example, the cloud sends the prediction result to the configuration management unit of the network device, and the configuration management unit sends the prediction result to the terminal.

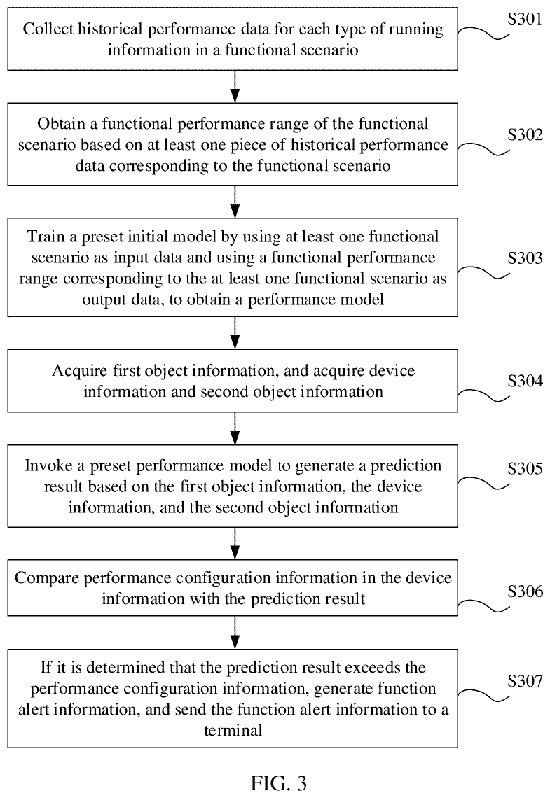

Referring to FIG. 3, this application provides a method for predicting device performance consumption. The method is applied to a network system and includes the following steps.

S301. Collect historical performance data for each type of running information in a functional scenario, where the functional scenario represents a function already enabled by a network device in the network system, the running information represents a quantity of terminals already connected to the network device in the network system, and the historical performance data represents a device performance indicator that is being consumed in the network system for a type of running information in the functional scenario.

Optionally, historical performance data for each type of running information in a functional scenario is collected, where the functional scenario represents a function already enabled by the network device in the network system and traffic of the network device, the running information represents a quantity of terminals already connected to the network device in the network system and traffic of the network device in the network system, and the historical performance data represents a device performance indicator that is being consumed in the network system for a type of running information in the functional scenario.

For example, from a functional dimension, different function combinations are obtained as different functional scenarios. For example, there are n (n is about 4 or 5) major functions that usually affect performance in the network device. A total quantity is 2 to the power of n, and if n is 4 or 5, the total quantity of function combinations is 15 to 31 (a case in which the quantity of function combinations is zero is not considered). Assuming that n is 4, functions of the network device include: A, B, C, and D. In this case, obtained function combinations include: A, B, C, D, AB, CD, AC, AD, BC, BD, ABC, BCD, ACD, ABD, and ABCD, where a combination without functions (that is, the network device does not enable any function) is not considered in this case.

A piece of running information represents a status of the network device in the network system when a quantity of connected terminals is M and the traffic of the network device is N, where M is a positive integer and N is a positive rational number.

Therefore, assuming that the functional scenario is AB, that is, function A and function B are both enabled, historical performance data for a type of running information in the functional scenario represents a device performance indicator consumed by the network device when a quantity of terminals already connected to the network device is Ma and traffic is Na, for example, one or more of CPU usage Ca, RAM usage Ra, and network bandwidth utilization Wa, where a∈[1, S], and S is a total quantity of functional scenario types.

In an exemplary embodiment, an information collection unit is used to collect terminal access configuration information, enablement information, and functional scenarios of the network device; the information collection unit is used to obtain the terminal access configuration information from configuration management of the network device; and the information collection unit is used to collect a quantity of terminals currently connected to the network device, the traffic of the network device, second function information of the network device, and a device performance indicator of the network device (for example, one or more of CPU usage, RAM usage, and network bandwidth utilization) from a data plane service of the network device.

The information collection unit sends the historical performance data and functional scenarios to an information gathering unit in the cloud, and the information gathering unit saves the historical performance data and functional scenarios in an information database in the cloud.

S302. Obtain a functional performance range of the functional scenario based on at least one piece of historical performance data corresponding to the functional scenario, where the functional performance range represents an upper limit and a lower limit of a device performance indicator of the network device consumable by a terminal in the functional scenario.

In this step, the functional performance range includes a device performance indicator consumable by a terminal in a plurality of functional scenarios in a scenario in which one or more functions are enabled. Therefore, the functional performance range covers a device performance indicator that may be consumed by a terminal for a plurality of types of running information, thereby ensuring comprehensiveness of device performance indicator prediction.

For example, assuming that the functional scenario is AB, an AB scenario in a plurality of functional scenarios (such as S scenarios) is obtained, that is, when the quantity of terminals already connected to the network device is M(1−S) and the traffic is N(1−S), the CPU usage is C (1−S), the RAM usage is R(1−S), and the network bandwidth utilization is W(1−S).

In an embodiment, the obtaining the functional performance range of the functional scenario based on the at least one piece of historical performance data corresponding to the functional scenario includes:
obtaining at least one piece of unit performance data in a target functional scenario based on at least one piece of historical performance data in the target functional scenario, where the unit performance data represents a device performance indicator consumed by a terminal in the target functional scenario;
performing a regression operation on each piece of unit performance data in the target functional scenario to obtain a regression curve of the target functional scenario, where the regression curve represents a probability that each category of unit performance data occurs in the target functional scenario, the category represents a value range to which a value of the unit performance data belongs, and the target functional scenario is one of at least one functional scenario; and
inputting a preset regression range into the regression curve to obtain a functional performance range of the target functional scenario, where the regression range is used to determine a target range for extracting the category in the regression curve, the target range determines at least one target category in the regression curve, the functional performance range is used to cover unit performance data in the at least one target category, an upper limit of the functional performance range is a first value in the unit performance data in the at least one target category, and a lower limit of the functional performance range is a second value in the unit performance data in the at least one target category. In this embodiment, the first value is a maximum value in the unit performance data in the at least one target category; and the second value is a minimum value in the unit performance data in the at least one target category.

Therefore, the regression operation is performed on each piece of unit performance data to obtain the regression curve, and the functional performance range in the regression curve is determined based on the regression range, where the regression range defines a difference degree range, that is, an upper limit value and a lower limit value of unit performance data within an N % range in the regression curve, for example, an upper limit and a lower limit of unit performance data with an exposure probability of 90% in the regression curve (a vast majority of the range in the curve), and the functional performance range is constructed based on the upper limit and the lower limit.

For example, it is determined that the regression curve is a normal distribution curve, and a regression range (for example, a 3σ range) of a performance loss of a single terminal under different function combinations is calculated. A quantity of terminals during peak hours of the network is acquired and multiplied by the corresponding 3σ range based on a combination of functions, to predict basically reliable performance data in the network, where represents a mean value of all unit performance data, σ represents a standard deviation of all unit performance data, the normal distribution curve represents a probability that each category of unit performance data occurs, and (μ−m×a, μ+m×σ) is used to represent the regression range, where m is an adjustment coefficient. By adjusting m, regression ranges with different upper thresholds and lower thresholds are obtained. The obtained regression range represents a percentage of an area covered by the normal distribution curve to a total area in the normal distribution curve within m standard deviations, centered on the mean value μ. For example, if a value of m is 1, (μ−σ, μ+σ) is obtained, which represents a percentage of an area covered by the normal distribution curve to a total area in the normal distribution curve within one standard deviation, centered on the mean value μ. Based on the standard normal distribution curve, [15.9%, 84.1%] is obtained, that is, 68.2% of the range centered on the mean value in the normal distribution curve is acquired.

It is assumed that there are six pieces of unit performance data in total, which are data a with a value of 1, data 2 with a value of 2, data 3 with a value of 3, data 4 with a value of 2, data 5 with a value of 1, and data 6 with a value of 1 respectively. In this case, an occurrence probability of the value being 1 is 50%; an occurrence probability of the value being 2 is 33%; and an occurrence probability of the value being 3 is 17%. If the adjustment coefficient is 1, the obtained regression range is 68.2%, which is expressed as [15.9%, 84.1%], where the upper threshold is 15.9%, and the lower threshold is 84.1%; and inputting the regression range into the regression curve represents acquisition of values corresponding to the unit performance data with an occurrence probability within 68.2% in the regression range. Therefore, obtained values are 1 and 2. Further, the upper limit of the functional performance range is 2, and the lower limit of the functional performance range is 1. The value of 3 is not used because the value being 3 is a low-probability event and is of no significance for reference. Therefore, this low-probability value can be excluded by using the foregoing regression range.

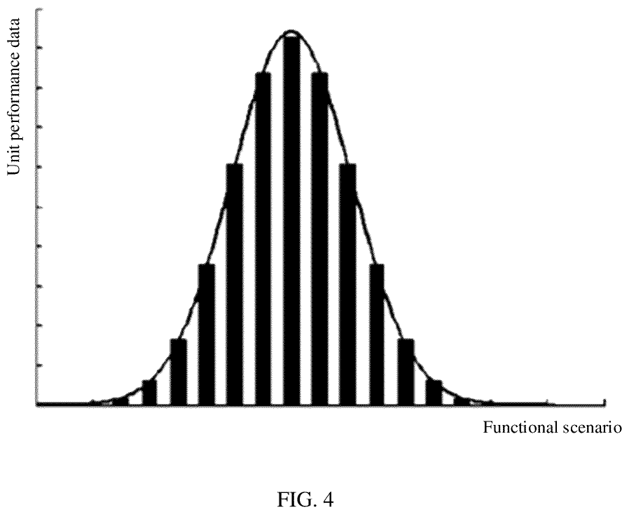

Specifically, device performance indicator consumption (that is, unit performance data) of a terminal under a function combination is calculated. For example, based on the quantity of terminals connected to the network device, CPU usage of a current data plane of the device (the consumed device performance indicator), an enabled function combination provided to the cloud (for example, function A and function B, not only data during peak hours, but also data during off-peak hours can be used for reference), and the data received by the cloud, performance P1 consumed by the single terminal in this network environment can be roughly calculated. The cloud performs statistics based on a large amount of data (more than 10000). In this case, the cloud may obtain more than 10000 data samples: P1, P2, . . . , Pn. These data samples are certainly discrete, but from a statistical perspective, the data samples necessarily conform to a normal distribution law. Therefore, the regression curve is a normal distribution curve, as shown in FIG. 4, where the normal distribution curve represents a functional scenario (function combination, such as AB), a vertical axis of the normal distribution represents a value of unit performance data, and a horizontal axis represents a functional scenario corresponding to each piece of unit performance data. For example, based on the foregoing distance, the adjustment coefficient m is set to 3, that is, the upper threshold is set to (μ+3σ), and the lower threshold is set to (μ−3σ). A probability of value distribution within ±3σ is 99.74%, and the regression range is obtained. A threshold range (μ−3σ, μ+3σ) corresponding to the regression range is substituted into the normal distribution curve to calculate a performance fluctuation range [Pn, Pm] of the functional scenario (the functions enabled by the network device are function A and function B).

Each functional scenario has its corresponding Fx[Pn, Pm], where x is any one of y functional scenarios and y is a total quantity of functional scenarios. In this way, a similar terminal performance range (3σ) under a function combination can be actually established, and this range can cover most scenarios.

| Function combination | Range of functional performance |
|---|---|
| (functional scenario) | consumed by a terminal |
| F1 | F1 [Pn, Pm] |
| F2 | F2 [Pn, Pm] |
| F3 | F3 [Pn, Pm] |
| F4 | F4 [Pn, Pm] |
| . . . | . . . |
| Fy | Fy [Pn, Pm] |

When a user is ready to make a function change, for example, switching from enabling function A (corresponding to functional scenario Fa) to enabling function A and function B (corresponding to functional scenario Fb), in this case, by obtaining a maximum quantity K of terminals on the network device, Fa[Pn, Pm]*K->Fb [Pn, Pm]*K can be calculated, where Fa[Pn, Pm]*K is a current range of performance consumption of the network device, and Fb[Pn, Pm]*K is a desired predicted range of device performance consumption.

S303. Train a preset initial model by using at least one functional scenario as input data and using a functional performance range corresponding to the at least one functional scenario as output data, to obtain a performance model.

In this step, a neural network or a support vector machine is used as the initial model. The neural network is a subset of machine learning and is also a core of a deep learning algorithm. A name and structure of the neural network are both inspired by the human brain and the neural network can imitate the way biological neurons transmit signals to each other. An artificial neural network (ANN, full name: Artificial Neural Network) consists of node layers, including an input layer, one or more hidden layers, and an output layer. Each node is also referred to as an artificial neuron, which is connected to another node and has an associated weight and threshold. If an output of any single node is higher than a specified threshold, the node is activated and data is sent to a next layer of the network. Otherwise, the data is not transmitted to the next layer of the network. The neural network relies on training data to learn and improve its accuracy over time.

The support vector machine (SVM, Support Vector Machine) is a machine learning algorithm used to resolve a binary classification problem. The support vector machine separates samples of different categories by finding a partitioning hyperplane in sample space, while maximizing a minimum distance from two point sets to this plane, that is, maximizing a distance from edge points of the two point sets to this plane.

Therefore, historical performance data for a plurality of types of running information in various functional scenarios is collected and used to train the initial model to obtain the performance model, thereby ensuring comprehensiveness of performance model training. For example, a data analysis unit in the cloud extracts historical performance data for each type of running information in a functional scenario from the information database, and the data analysis unit calculates and processes at least one piece of historical performance data for each type of running information to obtain the performance model, and saves the performance model to a model library in the cloud.

S304. Acquire first object information, and acquire device information and second object information, where the first object information represents an object that is ready to consume a device performance indicator of the network device in the network system, the device information represents a running status of the network device in the network system, and the second object information represents an object that is consuming a performance indicator of the network device in the network system.

This step is consistent with S201 in Embodiment 1, and therefore details are not described herein.

S305. Invoke a preset performance model to generate a prediction result based on the first object information, the device information, and the second object information, where the prediction result represents a device performance indicator that the network device in the network system consumes when the network device bears the objects corresponding to the first object information and the second object information.

This step is consistent with S202 in Embodiment 1, and therefore details are not described herein.

S306. Compare performance configuration information in the device information with the prediction result, where the performance configuration information represents maximum performance consumable by the network device.

For example, the performance configuration information includes a CPU usage limit value (for example, 98%), a RAM usage limit value (for example, 90%), and a network bandwidth utilization limit value (for example, 95%).

S307. If it is determined that the prediction result exceeds the performance configuration information, generate function alert information, and send the function alert information to the terminal.

For example, the prediction result indicates that if new function B is enabled on the network device, a device performance indicator that the network device will consume is CPU usage of 80%-99%. In this case, it is determined that the prediction result exceeds 98% in the performance configuration information, and therefore alert information needs to be generated and sent to the terminal.

Therefore, the performance configuration information is compared with the prediction result, and the function alert information is generated, to achieve a technical effect of timely feedback of a function enablement alarm.

Specifically, that function alert information is generated if it is determined that the prediction result exceeds the performance configuration information includes:
if it is determined that any device performance indicator in the prediction result exceeds performance configuration information corresponding to the device performance indicator, function alert information is generated. For example, it is assumed that the performance configuration information includes a CPU usage limit value (for example, 98%), a RAM usage limit value (for example, 90%) and a network bandwidth utilization limit value (for example, 95%). If the CPU usage in the prediction result reaches 80%-99%, it is determined that the prediction result exceeds the CPU usage limit value 98% in the performance configuration information.

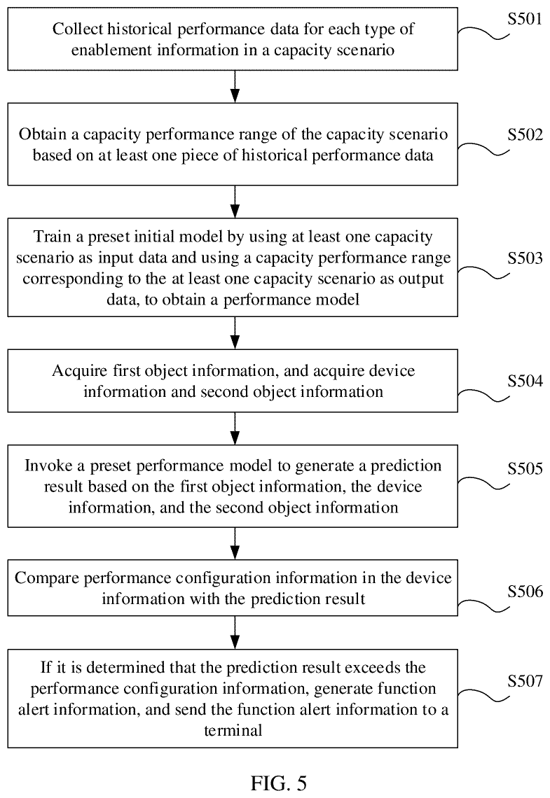

Referring to FIG. 5, this application provides a method for predicting device performance consumption. The method is applied to a network system and includes the following steps.

S501. Collect historical performance data for each type of enablement information in a capacity scenario, where the capacity scenario represents a quantity of terminals already connected to a network device in the network system, the enablement information represents a function already enabled by the network device in the network system, and the historical performance data represents a device performance indicator of the network device that is being consumed for a type of enablement information in the capacity scenario.

Optionally, historical performance data for each type of enablement information in a capacity scenario is collected, where the capacity scenario represents a quantity of terminals already connected to the network device in the network system, the enablement information represents a function already enabled by the network device in the network system and traffic of the network device, and the historical performance data represents a device performance indicator of the network device that is being consumed for a type of enablement information in the capacity scenario.

For example, in terms of the quantity of terminals connected to the network device, capacity scenarios with different quantities of terminals are acquired, for example, a scenario with 100 terminals, and a scenario with 200 terminals. Therefore, assuming that the capacity scenario is 1000, that is, the quantity of connected terminals is 1000, historical performance data of a functional scenario in the capacity scenario represents a device performance indicator of the network device in a functional scenario (for example, function A and function B are enabled) when 1000 terminals are connected to the network device. For example, each type of enablement information in a capacity scenario is collected. Assuming that the functions include function A and function B, various types of enablement information include: function A, function B, and functions A+B; and then the obtained historical performance data is historical performance data with function A enabled, historical performance data with function B enabled, and historical performance data with function A and function B enabled, when a quantity of connected terminals is 1000.

S502. Obtain a capacity performance range of the capacity scenario based on at least one piece of historical performance data, where the capacity performance range represents an upper limit and a lower limit of a device performance indicator consumed by the network device in the capacity scenario.

In this step, the capacity performance range includes device performance indicators consumed by the network device in different functional scenarios in the capacity scenario, that is, when the quantity of connected terminals is 1000, a device performance indicator consumed by enabling function A, a device performance indicator consumed by enabling function A and function B, and so on. In other words, the capacity performance range of the network device when the quantity of connected terminals is 1000 is determined based on the foregoing historical performance data. Assuming that performance consumption of function A is the smallest, the lower limit of the range is minimum performance consumption data when function A is enabled, and the upper limit is maximum performance consumption data when function A and function B are enabled. The purpose is that if the quantity of terminals connected to the network device reaches 1000 due to addition of a new terminal, no matter how subsequent functions are enabled, performance of the network device will not exceed the threshold. A regression operation is performed on the historical performance data in each functional scenario to obtain a regression curve of the capacity scenario. A preset regression range is input into the regression curve to obtain the capacity performance range, where the regression range includes an upper threshold and a lower threshold, the upper threshold represents an upper limit of a difference degree between at least one piece of historical performance data, and the lower threshold represents a lower limit of a difference degree between at least one piece of historical performance data.

For example, in a capacity scenario, such as a scenario with 1000 terminals, when different functions are enabled, different device performance indicators occur, and each device performance indicator conforms to a normal distribution curve. For example, according to a 3σ principle, the upper threshold is set to (μ+3σ) and the lower threshold is set to (μ−3σ). A probability of value distribution within ±3σ is 99.74%, and a regression range is obtained, where is a mean value of all unit performance data and a is a standard deviation of all unit performance data. The 3σ principle means that the probability of the value distribution within (μ−3σ, μ+3σ) is 0.9974, where a represents the standard deviation in the normal distribution, represents the mean value, and x=μ, which is an axis of symmetry for an image. The 3σ criterion is also referred to as a Pauta criterion. It first assumes that a set of detection data includes only random errors, calculates and processes the data to obtain a standard deviation, and determines a range based on a probability. Any error exceeding this range is considered as a gross error rather than a random error, and data including this error should be excluded. 3σ is suitable when there are more sets of data.

Optionally, the historical performance data has a time period, which represents the time of the historical performance data. Assuming that in a functional scenario in which enabled functions are function A and function B, based on at least one piece of historical performance data, an obtained capacity performance range in the capacity scenario includes at least one time capacity performance range, for example, the time period includes 0:00 to 12:00, and 12:00 to 24:00, and the following ranges are obtained: a time capacity performance range of 0:00 to 12:00, which represents a device performance indicator consumed when 1000 terminals are connected to the network device and function A and function B are enabled; and a time capacity performance range of 12:00 to 24:00, which represents a device performance indicator consumed when 1000 terminals are connected to the network device and function A and function B are enabled.

S503. Train a preset initial model by using at least one capacity scenario as input data and using a capacity performance range corresponding to the at least one capacity scenario as output data, to obtain a performance model.

In this step, a neural network or a support vector machine is used as the initial model. The neural network is a subset of machine learning and is also a core of a deep learning algorithm. A name and structure of the neural network are both inspired by the human brain and the neural network can imitate the way biological neurons transmit signals to each other. An artificial neural network (ANN) consists of node layers, including an input layer, one or more hidden layers, and an output layer. Each node is also referred to as an artificial neuron, which is connected to another node and has an associated weight and threshold. If an output of any single node is higher than a specified threshold, the node is activated and data is sent to a next layer of the network. Otherwise, the data is not transmitted to the next layer of the network. The neural network relies on training data to learn and improve its accuracy over time.

The support vector machine (Support Vector Machine, SVM for short) is a machine learning algorithm used to solve a binary classification problem. The support vector machine separates samples of different categories by finding a partitioning hyperplane in sample space, while maximizing a minimum distance from two point sets to this plane and maximizing a distance from edge points of the two point sets to this plane.

Therefore, historical performance data in a plurality of functional scenarios in various capacity scenarios is collected and used to train the initial model to obtain the performance model, thereby ensuring comprehensiveness of performance model training.

S504. Acquire first object information, and acquire device information and second object information, where the first object information represents an object that is ready to consume a device performance indicator of the network device in the network system, the device information represents a running status of the network device in the network system, and the second object information represents an object that is consuming a performance indicator of the network device in the network system.

This step is consistent with S201 in Embodiment 1, and therefore details are not described herein.

S505. Invoke a preset performance model to generate a prediction result based on the first object information, the device information, and the second object information, where the prediction result represents a device performance indicator that the network device in the network system consumes when the network device runs the objects corresponding to the first object information and the second object information.

This step is consistent with S202 in Embodiment 1, and therefore details are not described herein.

S506. Compare performance configuration information in the device information with the prediction result, where the performance configuration information represents a device performance indicator threshold consumable by the network device.

In this embodiment, the device performance indicator threshold may represent a maximum device performance indicator consumable by the network device.

For example, the performance configuration information includes a CPU usage limit value (for example, 98%), a RAM usage limit value (for example, 90%), and a network bandwidth utilization limit value (for example, 95%).

S507. If it is determined that the prediction result exceeds the performance configuration information, generate function alert information, and send the function alert information to the terminal.

For example, the prediction result indicates that if new function B is enabled on the network device, a device performance indicator that the network device will consume is CPU usage of 80%-99%. In this case, it is determined that the prediction result exceeds 98% in the performance configuration information, and therefore alert information needs to be generated and sent to the terminal.

Therefore, the performance configuration information is compared with the prediction result, and the function alert information is generated, to achieve a technical effect of timely feedback of a function enablement alarm.

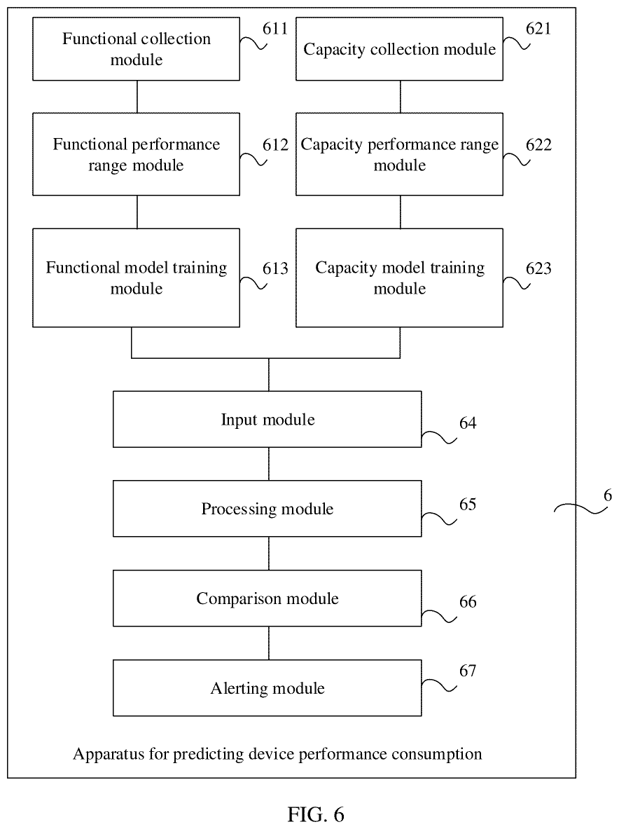

Referring to FIG. 6, an embodiment of this application provides an apparatus 6 for predicting device performance consumption. The apparatus is installed in a network system and includes:
an input module 64, configured to acquire first object information, and acquire device information and second object information, where the first object information represents an object that is ready to consume a device performance indicator of a network device in the network system, the device information represents a running status of the network device in the network system, and the second object information represents an object that is consuming a performance indicator of the network device in the network system; and
a processing module 65, configured to invoke a preset performance model to generate a prediction result based on the first object information, the device information, and the second object information, where the prediction result represents a device performance indicator that the network device consumes when the network device in the network system bears the objects corresponding to the first object information and the second object information.

Optionally, the first object information includes first function information, and the second object information includes second function information; and
the input module 64 is further configured to receive the first function information sent by a terminal, and acquire the device information and the second function information, where the first function information represents a function that the terminal is ready to enable, the device information includes terminal access configuration information and running information, the terminal access configuration information represents a threshold for a quantity of terminals allowed to connect to the network device, the running information includes a quantity of terminals already connected to the network device, and the second function information represents a function already enabled by the network device in the network system. In this embodiment, the quantity threshold is a maximum quantity of terminals allowed to connect to the network device.

The processing module 65 is further configured to invoke the preset performance model to generate a target function range based on the first function information, the second function information, and the running information in the device information, where the target function range refers to an upper limit and a lower limit of a device performance indicator consumable by a terminal connected to the network device when the network device in the network system enables the function for the first function information and the function for the second function information; and
the processing module 65 is further configured to determine a prediction result of the first function information based on the terminal access configuration information in the device information and the target function range.

Optionally, the network system includes a cloud and at least one network device; and a processing module 65 is disposed in the cloud;
the processing module 65 in the cloud is configured to input the first function information, the second function information, and running information in first device information into a preset performance analysis interface, where the first device information refers to device information of a first network device, and the first network device is a network device that is of the at least one network device and that receives the first function information sent by the terminal; and
the processing module 65 in the cloud is configured to invoke the performance model through the performance analysis interface, so that the performance model generates the target function range based on the first function information, the running information in the first device information, and the second function information.

Optionally, the processing module 65 in the cloud is configured to multiply terminal access configuration information in first device information by the upper limit and the lower limit in the target function range respectively to obtain a predicted upper limit value and a predicted lower limit value; and
the processing module 65 in the cloud is configured to construct a value range based on the predicted upper limit value and the predicted lower limit value, and use the value range as the prediction result.

Optionally, the first object information includes first capacity information, and the second object information includes second capacity information; and
the input module 64 is further configured to receive the first capacity information sent by a terminal, and acquire the device information and the second capacity information, where the first capacity information represents a quantity of terminals that the network device in the network system is ready to add, the device information includes enablement information, the enablement information represents a function enabled by the network device in the network system, and the second capacity information represents a quantity of terminals already connected to the network device in the network system.

Optionally, the processing module 65 is further configured to invoke the preset performance model to generate a target capacity range based on the first capacity information, the second capacity information, and the enablement information in the device information, and use the target capacity range as a prediction result of the first capacity information, where the target capacity range refers to an upper limit and a lower limit of a device performance indicator consumed by the network device when a total of a first quantity and a second quantity of terminals are connected to the network device in the network system, the first quantity is a quantity of terminals corresponding to the first capacity information, and the second quantity is a quantity of terminals corresponding to the second capacity information.

Optionally, the apparatus 6 further includes: a functional collection module 611, configured to collect historical performance data for each type of running information in a functional scenario, where the functional scenario represents a function already enabled by the network device in the network system, running information represents a quantity of terminals already connected to the network device in the network system, and the historical performance data represents a device performance indicator that is being consumed in the network system for a type of running information in the functional scenario;
a functional performance range module 612, configured to obtain a functional performance range of the functional scenario based on at least one piece of historical performance data corresponding to the functional scenario, where the functional performance range represents an upper limit and a lower limit of a device performance indicator of the network device consumable by a terminal in the functional scenario; and
a functional model training module 613, configured to train a preset initial model by using at least one functional scenario as input data and using a functional performance range corresponding to the at least one functional scenario as output data, to obtain the performance model.

Optionally, the apparatus 6 further includes:
the functional performance range module 612 is further configured to obtain at least one piece of unit performance data in a target functional scenario based on at least one piece of historical performance data in the target functional scenario, where the unit performance data represents a device performance indicator consumed by a terminal in the target functional scenario;
the functional performance range module 612 is further configured to perform a regression operation on each piece of unit performance data in the target functional scenario to obtain a regression curve of the target functional scenario, where the regression curve represents a probability that each category of unit performance data occurs in the target functional scenario, the category represents a value range to which a value of the unit performance data belongs, and the target functional scenario is one of the at least one functional scenario; and
the functional performance range module 612 is further configured to input a preset regression range into the regression curve to obtain a functional performance range of the target functional scenario, where the regression range is used to determine a target range for extracting the category in the regression curve, the target range determines at least one target category in the regression curve, the functional performance range is used to cover unit performance data in the at least one target category, an upper limit of the functional performance range is a first value in the unit performance data in the at least one target category, and a lower limit of the functional performance range is a second value in the unit performance data in the at least one target category.

Optionally, the apparatus 6 further includes: a capacity collection module 621, configured to collect historical performance data for each type of enablement information in a capacity scenario, where the capacity scenario represents a quantity of terminals already connected to the network device in the network system, the enablement information represents a function already enabled by the network device in the network system, and the historical performance data represents a device performance indicator of the network device that is being consumed for a type of enablement information in the capacity scenario;
a capacity performance range module 622, configured to obtain a capacity performance range of the capacity scenario based on at least one piece of historical performance data, where the capacity performance range represents an upper limit and a lower limit of a device performance indicator consumed by the network device in the capacity scenario; and
a capacity model training module 623, configured to train a preset initial model by using at least one capacity scenario as input data and using a capacity performance range corresponding to the at least one capacity scenario as output data, to obtain the performance model.

Optionally, the apparatus 6 further includes:
a comparison module 66, configured to compare performance configuration information in the device information with the prediction result, where the performance configuration information represents a device performance indicator threshold consumable by the network device; and
an alerting module 67, configured to generate function alert information if it is determined that the prediction result exceeds the performance configuration information.

To achieve the foregoing objective, this application further provides a computer device 7, including a processor 72 and a memory 71 communicatively connected to the processor 72. The memory stores computer-executable instructions.

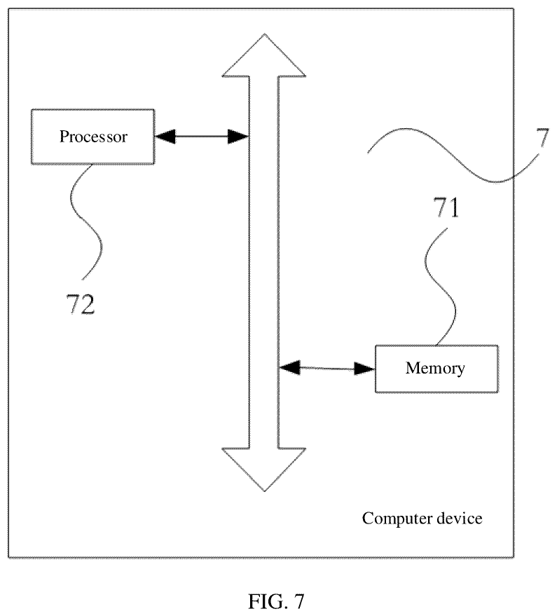

The processor executes the computer-executable instructions stored in the memory 71, to implement the foregoing method for predicting device performance consumption. Components of an apparatus for predicting device performance consumption may be distributed in different computer devices. The computer device 7 may be a smartphone, a tablet computer, a laptop computer, a desktop computer, a rack server, a blade server, a tower server, a cabinet server (including a stand-alone server, or a server cluster formed by a plurality of application servers), or the like that executes a program. The computer device in this embodiment includes but is not limited to at least the memory 71 and the processor 72 that can be communicatively interconnected by a system bus, as shown in FIG. 7. It should be noted that FIG. 7 shows only a computer device with components. It should be understood that not all the shown components are mandatory for implementation and that more or fewer components can be implemented instead. In this embodiment, the memory 71 (that is, a readable storage medium) includes a flash memory, a hard disk, a multimedia card, a card-type memory (for example, an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, or the like. In some embodiments, the memory 71 may be an internal storage unit of the computer device, for example, a hard disk or a memory of the computer device. In some other embodiments, the memory 71 may alternatively be an external storage device of the computer device, for example, a plug-in hard disk, a smart media card (SMC, full name: Smart Media Card), a secure digital (SD, full name: Secure Digital) card, a flash card (Flash Card), or the like that is provided in the computer device. Certainly, the memory 71 may further include both the internal storage unit of the computer device and the external storage device of the computer device. In this embodiment, the memory 71 is generally configured to store an operating system and various application software installed in the computer device, for example, program code for the apparatus for predicting device performance consumption in Embodiment 3. In addition, the memory 71 may be further configured to temporarily store various data that has been output or that is ready to be output. In some embodiments, the processor 72 may be a central processing unit (CPU, full name: Central Processing Unit), a controller, a microcontroller, a microprocessor, or another data processing chip. The processor 72 is usually configured to control overall operations of the computer device. In this embodiment, the processor 72 is configured to run the program code stored in the memory 71 or process data, for example, run the apparatus for predicting device performance consumption, to implement the method for predicting device performance consumption in the foregoing embodiment.

The foregoing integrated module implemented in a form of a software functional module may be stored in a computer-readable storage medium. The software functional module is stored in a storage medium and includes several instructions for instructing the computer device (which may be a personal computer, a server, a network device, or the like) or the processor to perform some steps of the methods described in the embodiments of this application. It should be understood that the processor may be a central processing unit (CPU, full name: Central Processing Unit), or may be another general-purpose processor, digital signal processor (DSP, full name: Digital Signal Processor), application-specific integrated circuit (ASIC, full name: Application-Specific Integrated Circuit), or the like. The general-purpose processor may be a microprocessor, or the processor may be any conventional processor or the like. The steps of the methods disclosed with reference to this application may be directly performed and completed by a hardware processor, or may be performed and completed by using a combination of hardware in the processor and a software module. The memory may include a high-speed RAM memory, or may further include a nonvolatile memory NVM, for example, at least one magnetic disk memory, or may be a USB flash drive, a removable hard disk, a read-only memory, a magnetic disk, an optical disc, or the like.

To achieve the foregoing objective, this application further provides a computer-readable storage medium, such as a flash memory, a hard disk, a multimedia card, a card-type memory (for example, an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, a server, an App application store, or the like. The computer-readable storage medium stores computer-executable instructions, and corresponding functions are implemented when the program is executed by the processor 72. The computer-readable storage medium in this embodiment is configured to store computer-executable instructions for implementing the method for predicting device performance consumption, and when the computer-executable instructions are executed by the processor 72, the method for predicting device performance consumption in the foregoing embodiment is implemented.

The storage medium may be implemented by using any type of volatile or nonvolatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk. The storage medium may be any available medium accessible to a general-purpose or dedicated computer.

For example, the storage medium is coupled to the processor, so that the processor can read information from the storage medium or write information into the storage medium. Certainly, the storage medium may alternatively be a component of the processor. The processor and the storage medium may be located in an application-specific integrated circuit ASIC, full name: Application Specific Integrated Circuit). Certainly, the processor and the storage medium may also exist in an electronic device or a main control device as separate components.

This application provides a computer program product including a computer program. When the computer program is executed by a processor, the foregoing method for predicting device performance consumption is implemented.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element.

A person skilled in the art will easily think of other implementation solutions of this application after considering the specification and practicing the present invention disclosed herein. This application is intended to cover any variations, purposes, or adaptive changes of this application. These variations, purposes, or adaptive changes comply with the general principles of this application and include common knowledge or conventional technical means in the technical field that are not disclosed in this application. The specification and the embodiments are considered as exemplary only. The true scope and spirit of this application are indicated by the following claims.

It should be understood that this application is not limited to the precise structure described above and shown in the drawings, and various modifications and changes can be made without departing from the scope of this application. The scope of this application is defined only by the appended claims.

What is claimed is:

1. A method for predicting device performance consumption, wherein the method is applied to a network system, and the method comprises:
acquiring first object information, acquiring device information, and second object information, wherein the first object information represents a first object that is ready to consume a device performance indicator of a network device in the network system, the device information represents a running status of the network device in the network system, and the second object information represents a second object that is consuming a performance indicator of the network device in the network system; and
invoking a preset performance model to generate a prediction result based on the first object information, the device information, and the second object information, wherein the prediction result represents a device performance indicator that the network device needs to consume when the network device in the network system bears the first object and the second object.

2. The method according to claim 1, wherein the first object information comprises first function information, and the second object information comprises second function information; and
the acquiring the first object information, and acquiring the device information and the second object information comprises:
receiving the first function information sent by a terminal, and acquiring the device information and the second function information, wherein the first function information represents a function that the terminal is ready to enable, the device information comprises terminal access configuration information and running information, the terminal access configuration information represents a threshold for a quantity of terminals allowed to connect to the network device, the running information comprises a quantity of terminals already connected to the network device, and the second function information represents a function already enabled by the network device in the network system.

3. The method according to claim 2, wherein invoking the preset performance model to generate the prediction result based on the first object information, the device information, and the second object information comprises:
invoking the preset performance model to generate a target function range based on the first function information, the second function information, and the running information in the device information, wherein the target function range refers to an upper limit and a lower limit of a device performance indicator consumable by a terminal connected to the network device when the network device in the network system enables the function for the first function information and the function for the second function information; and
determining a prediction result of the first function information based on the terminal access configuration information in the device information and the target function range.

4. The method according to claim 3, wherein the network system comprises a cloud and at least one second network device; and
invoking the preset performance model to generate the target function range based on the first function information, the second function information, and the running information in the device information comprises:
inputting, by the cloud, the first function information, the second function information, and running information in first device information into a preset performance analysis interface, wherein the first device information refers to device information of a first network device, and the first network device is a network device that is of the at least one second network device and that receives the first function information sent by the terminal; and
invoking, by the cloud, the performance model through the performance analysis interface, so that the performance model generates the target function range based on the first function information, the running information in the first device information, and the second function information.

5. The method according to claim 3, wherein the network system comprises a cloud and at least one second network device; and
determining the prediction result of the first function information based on the terminal access configuration information in the device information and the target function range comprises:
multiplying, by the cloud, terminal access configuration information in first device information by the upper limit and the lower limit in the target function range respectively to obtain a predicted upper limit value and a predicted lower limit value, wherein the first device information refers to device information of a first network device, and the first network device is a network device that is of the at least one second network device and that receives the first object information sent by the terminal; and
constructing, by the cloud, a value range based on the predicted upper limit value and the predicted lower limit value, and using the value range as the prediction result.

6. The method according to claim 1, wherein the first object information comprises first function information, and the second object information comprises second function information; and
invoking the preset performance model to generate the prediction result based on the first object information, the device information, and the second object information comprises:
invoking the preset performance model to generate a target function range based on the first function information in the first object information, the second function information in the second object information, and running information in the device information, wherein the target function range refers to an upper limit and a lower limit of a device performance indicator consumable by a terminal connected to the network device when the network device in the network system enables a function for the first function information and a function for the second function information; and
determining a prediction result of the first function information based on terminal access configuration information in the device information and the target function range.

7. The method according to claim 1, wherein the first object information comprises first capacity information, and the second object information comprises second capacity information; and
acquiring the first object information, and acquiring the device information and the second object information comprises:
receiving the first capacity information sent by a terminal, and acquiring the device information and the second capacity information, wherein the first capacity information represents a quantity of terminals that the network device in the network system is ready to add, the device information comprises enablement information, the enablement information represents a function enabled by the network device in the network system, and the second capacity information represents a quantity of terminals already connected to the network device in the network system.

8. The method according to claim 7, wherein invoking the preset performance model to generate the prediction result based on the first object information, the device information, and the second object information comprises:
invoking the preset performance model to generate a target capacity range based on the first capacity information, the second capacity information, and the enablement information in the device information, and using the target capacity range as a prediction result of the first capacity information, wherein the target capacity range refers to an upper limit and a lower limit of a device performance indicator consumed by the network device when a total of a first quantity and a second quantity of terminals are connected to the network device in the network system, the first quantity is a quantity of terminals corresponding to the first capacity information, and the second quantity is a quantity of terminals corresponding to the second capacity information.

9. The method according to claim 1, wherein before acquiring the first object information, and acquiring the device information and the second object information, the method further comprises:
collecting historical performance data for each type of running information in a functional scenario, wherein the functional scenario represents a function already enabled by the network device in the network system, running information in the device information represents a quantity of terminals already connected to the network device, and the historical performance data represents a device performance indicator that is being consumed in the network system for a type of running information in the functional scenario;
obtaining a functional performance range of the functional scenario based on at least one piece of historical performance data corresponding to the functional scenario, wherein the functional performance range represents an upper limit and a lower limit of a device performance indicator of the network device consumable by a terminal in the functional scenario; and
training a preset initial model by using the functional scenario as input data and using a functional performance range corresponding to the at least one functional scenario as output data, to obtain the performance model.

10. The method according to claim 9, wherein obtaining the functional performance range of the functional scenario based on the at least one piece of historical performance data corresponding to the functional scenario comprises:
obtaining at least one piece of unit performance data in a target functional scenario based on at least one piece of historical performance data in the target functional scenario, wherein the unit performance data represents a device performance indicator consumed by a terminal in the target functional scenario;
performing a regression operation on the at least one piece of unit performance data in the target functional scenario to obtain a regression curve of the target functional scenario, wherein the regression curve represents a probability that each category of the at least one piece of unit performance data occurs in the target functional scenario, the category represents a value range to which a value of the at least one piece of unit performance data belongs, and the target functional scenario is one of the at least one functional scenario; and
inputting a preset regression range into the regression curve to obtain a functional performance range of the target functional scenario, wherein the regression range is used to determine a target range for extracting the category in the regression curve, the target range determines at least one target category in the regression curve, the functional performance range is used to cover unit performance data in the at least one target category, an upper limit of the functional performance range is a first value in the unit performance data in the at least one target category, and a lower limit of the functional performance range is a second value in the unit performance data in the at least one target category.

11. The method according to claim 1, wherein before acquiring the first object information, and acquiring the device information and the second object information, the method further comprises:
collecting historical performance data for each type of enablement information in a capacity scenario, wherein the capacity scenario represents a quantity of terminals already connected to the network device in the network system, the enablement information represents a function already enabled by the network device in the network system, and the historical performance data represents a device performance indicator of the network device that is being consumed for a type of enablement information in the capacity scenario;
obtaining a capacity performance range of the capacity scenario based on at least one piece of historical performance data, wherein the capacity performance range represents an upper limit and a lower limit of a device performance indicator consumed by the network device in the capacity scenario; and
training a preset initial model by using at least one capacity scenario as input data and using a capacity performance range corresponding to the at least one capacity scenario as output data, to obtain the performance model.

12. The method according to claim 1, wherein after invoking the preset performance model to generate the prediction result based on the first object information, the device information, and the second object information, the method further comprises:
comparing performance configuration information in the device information with the prediction result, wherein the performance configuration information represents a device performance indicator threshold consumable by the network device; and
when it is determined that the prediction result exceeds the performance configuration information, generating function alert information.

13. The method according to claim 1, wherein invoking the preset performance model to generate the prediction result based on the first object information, the device information, and the second object information comprises:
invoking the preset performance model to generate a target capacity range based on first capacity information in the first object information, second capacity information in the second object information, and enablement information in the device information, and using the target capacity range as a prediction result of the first capacity information, wherein the target capacity range refers to an upper limit and a lower limit of a device performance indicator consumed by the network device when a total of a first quantity and a second quantity of terminals are connected to the network device in the network system, the first quantity is a quantity of terminals corresponding to the first capacity information, and the second quantity is a quantity of terminals corresponding to the second capacity information.

14. A computer device, comprising a processor and a memory communicatively connected to the processor, wherein
the memory stores computer-executable instructions; and
the processor executes the computer-executable instructions stored in the memory, to implement the method for predicting device performance consumption according to claim 1.

15. A non-transitory computer-readable storage medium, wherein the non-transitory computer-readable storage medium stores computer-executable instructions, and, when executed by a processor, the computer-executable instructions are used to implement the method for predicting device performance consumption according to claim 1.
